(19) United States
(12) Patent Application Publication
(10) Pub. No.: US 2002/0019769 A1
(43) Pub. Date: Feb. 14, 2002

(54) System and method for establishing incentives for promoting the exchange of personal information and targeted advertising

(76) Inventors: Steven Barritz, Woodbury, NY (US); Robert Barritz, Syosset, NY (US)

Correspondence Address: OSTROLENK FABER GERB & SOFFEN, 1180 AVENUE OF THE AMERICAS, NEW YORK, NY, 100368403

(21) Appl. No.: 09/766,438

(22) Filed: Jan. 19, 2001

Related U.S. Application Data
(60) Provisional application No. 60/176,841, filed on Jan. 19, 2000.

(51) Int. Cl. G06F 17/60

(52) U.S. Cl. 705/14

(57) ABSTRACT

A system and method for over-the-air and/or other types of broadcasting which creates incentives that promote the exchange of personal information of viewers in return for a more viewer-tailored program content as well as advertising content. The invention includes a content selector that selects program content, and an advertising inserter that is controlled by reference to viewers' personal profiles.

### RELATED APPLICATION

This application claims priority and is entitled to the filing date of U.S. Provisional Application Ser. No. 60/176,841 filed Jan. 19, 2000, and entitled “SYSTEM AND METHOD FOR ESTABLISHING INCENTIVES FOR PROMOTING THE EXCHANGE OF PERSONAL INFORMATION AND TARGETED ADVERTISING,” the contents of which are incorporated by reference herein.

### BACKGROUND OF THE INVENTION

The present invention is generally concerned with the field of over the air or other types of broadcasting and, more specifically, with a system and method for creating incentives that promote the exchange of personal information by viewers and listeners for targeted advertising by the broadcasters.

With the exception of pay and premium channels, television viewers are routinely bombarded with a plethora of commercial advertisements with the express purpose of promoting products and services. A standard one hour television program contains about sixteen minutes of commercials and other “spots”. It is no wonder then that many viewers desire to be exposed to few, if any, commercials. Broadcasters claim that they provide the programming that “delivers” viewers to the commercials and that it is then up to the advertisers to keep the viewers' attention. A common concern and fear among broadcasters is that they will lose their viewers to other stations during the commercial breaks.

For the most part, only an extremely small percentage of these viewers pay attention to these commercials. Furthermore, they tend to only watch commercials for products for which they have an immediate need, interest or curiosity.

Commercial ad rates for a given station and programs are based upon the number of viewers and their demographics. Advertisers pay to reach 100% of that viewing audience. If only 2% of viewers actually watch television commercials, then 98% of the money spent to reach viewers is lost.

It would seem intuitive that an advertiser would get the same benefit for fewer dollars by delivering (narrow casting) commercials to viewers that are receptive to watching them. Furthermore, certain advertisers would greatly value the ability to immediately reach loyal customers as opposed to a more general audience. For example, a manufacturer of golfing equipment would value the ability to present his advertisement to “known” golfers, preferably golfers who spend $500 a year on equipment, and even more so golfers who spend over $5,000 a year.

One of the methods for achieving this is the practice of targeting ads to specific audiences. The concept of targeted ads is not new, however; it is seen in the advertising industry as a viable approach of tunneling down through the general populace to reach the right audience. There are problems and difficulties associated with following this approach as:

1. Most viewers would prefer few, if any, commercials;

2. Narrow casting of the targeted advertisements to a diverse populace is difficult; and

3. Determining the demographics, interests, buying habits, etc. of the intended audience is a further challenge.

Prior art methods and apparatus for delivering targeted ads, once the target audience is identified, have been described, e.g. in WO9828906, U.S. Pat. No. 5,774,170 and WO9721183. In one form or another, the methodology consists of substituting a targeted ad for the regular commercial. While addressing the need to have a database of viewers to whom the ads are to be targeted, the prior art is deficient as to how to obtain reliable information to populate it. Secondly, the prior art does not address features such as reducing the number of commercials or repackaging them into pods, i.e. a group of consecutively aired commercials.

Obtaining accurate and timely demographic and life-style profiles is a difficult and costly process. Manufacturers routinely use warranty registration cards to identify their customers and determine this type of data. However, many people are either lazy or, very commonly, reluctant to reveal personal information such as income, buying habits, etc.

Moreover, it is well-known in the advertising community that there are special groups of viewers that are hard to reach, i.e., obtaining their data is difficult, considerably more costly and, often times, of poorer statistical accuracy.

Media research companies like Nielsen Media Research and Arbitron Ratings spend considerable sums of money to determine the demographics of all viewers. While the methods vary, census, purchasing (purchasing information is routinely reported from credit cards, record sales, grocery stores, consumer surveys and other sources by organizations that collect such data) and other geographical data are combined to determine the aggregate profile of a given viewing area. These profile factors typically include age, income, family composition, number of children and their ages, type of automobile owned, dwelling type, zip code and various other demographic and life-style information.

Generally, such profile data for certain demographic groups is accurate but it may be months or even years out of date and the precision is insufficient to permit the narrow casting of closely targeted ads to a specific individual. More specific and timely data is required. It is also well known that for certain demographic groups such information is sparse and inaccurate. Hence, accurate and timely data is of more value to certain advertisers.

Hereinafter, these profile factors supplemented with timely and accurate data detailing income, buying habits, financial data, personal interests, etc. are referred to as personal profiles. The granularity of such data can range from coarse to very fine. For example, coarse data might be limited to the viewer's age, gender and basic life-style information, whereas, better quality data might start with the inclusion of recent major purchases and top out with a complete financial disclosure (credit card purchases, debit card purchases, bank records, stock portfolio, etc.).

### SUMMARY OF THE INVENTION

Accordingly, it is an object of the present invention to provide a system and method for creating incentives that promote the exchange of personal information by viewers and listeners for targeted advertising by broadcasters.

It is another object of the present invention to provide a system and method that produces more reliable and up-to-date personal profiles about viewers of broadcasted shows and information.

Yet another object of the invention is to provide a system and method that produces up-to-date and accurate demographics of all viewers.

Still another object of the invention is to provide a system and method that enhances the ability of broadcasters to channel and provide specific programming content and specific commercial advertising content to specific viewers.

The foregoing and other objects of the invention are realized with the method and system of the invention that achieves the foregoing objects through a variety of means including conventional broadcasting as well as through broadcasting through cable TV, satellite signals, digital signals or personal television products and the like.

Generally, the system of the present invention comprises hardware and software that serves to collect personal and demographic data from viewers/households and prepares corresponding viewer profiles and demographics. One component of the invention is a content selector (CS) that provides the programming to viewers commensurate with viewers' requests for content and the broadcasters' knowledge of the viewers' demographic profiles. Another component of the invention is an ad inserter (AI) which attends to the task of inserting carefully selected advertising material into corresponding program content that is transmitted to the viewers/households.

Further subsystems and components of the invention perform management and control tasks as, for example, viewer identification, collection of data on viewers' preferred content, other preferences, frequency and type of television watching, viewers' reward records (historical and current), general communication with viewers, etc.

The invention is applicable to a variety of broadcasting formats including such formats as point-to-point broadcasting, point-to-few broadcasting and point-to-many broadcasting. The common television systems are an example of a point-to-many broadcasting mode where there is not much choice in providing different programming content and advertisement that can be broadcast to groups, let alone specific households.

Other features and advantages of the present invention will become apparent from the following description of the invention which refers to the accompanying drawings.

### BRIEF DESCRIPTION OF THE DRAWINGS

FIG. 1 is an overall diagrammatic layout illustrating a first embodiment of the present invention.

FIG. 2 is a flow chart of various steps of the invention implicating the prompting of viewers for profile information.

FIG. 3 is a top level flow chart of a normal running process in accordance with an embodiment of the present invention.

### DETAILED DESCRIPTION OF THE INVENTION

A settop converter accepts cable TV or satellite signals and converts them for display on the viewer's TV set, VCR, or personal television product (PTV). Most units, the newer ones especially, are individually addressable so that signals delivered over the cable or satellite can be used by the broadcasting or cable system operator to enable or disable certain channels and/or services to specific households and, indeed, to even a specific TV, VCR or PTV.

PTVs also connect in-between the television and cable settop box, satellite receiver or antenna. They enable viewers to change channels, record programs of interest, and watch them when they want. Some PTVs (for example, RealTV and TiVo) include features such as live TV buffering (the ability to pause/rewind television shows as they are broadcast), simultaneous digital recording and playback (the ability to watch a show while recording another), short-term archival of recordings, dumping of recordings to videotape for long-term archival, an electronic program guide, and timed recordings.

The present invention is described in terms of television advertising, however, it is equally operative for advertising over the Internet, various forms of interactive television (e.g., WebTV, RealTV), Radio and Audio on Demand (e.g., Internet radio), and various forms of video and Video on Demand (including CATV, satellite, Internet Television, etc.).

It is the objective of the present invention to overcome the problem of obtaining personal profile data by enabling advertisers to motivate individuals to cooperate in the gathering of the data, allowing advertisers to:

identify a targeted audience;

obtain personal profile data and then continually update that data;

obtain the corresponding profile data of close family members and then continually update that data;

analyze such data to determine the appropriate type and frequency of a targeted ad;

deliver targeted advertisements to participating viewers;

deliver targeted ads on a prioritized basis to participating viewers;

reward viewers for watching targeted ads; and,

reward viewers in return for their divulging personal information.

To overcome the reluctance of viewers to reveal personal buying habits, income and other information, the present invention provides for various rewards or incentives that can be used:

1. Viewers can be paid via coupons and/or cash;

2. The number of commercials, their frequency and/or duration can be reduced; for example, a targeted ad system may provide cooperating viewers with one of 16 different reward levels for a particular program—zero commercials, 1 minute of commercials per hour, 2 minutes, and so on. Their frequency can also be adjusted so that, for example, a total 8 minutes of commercials are shown in 1, 2 or 4 pods.

3. Targeted commercials are presented in a fewer number of fixed pods; As in the preceding example, a program may be narrow casted that contains only 6 commercials pods to reward cooperating viewers (or 4 for highly rewarded viewers) instead of the regular 8.

4. Only commercials that closely match the viewer's personal profile are aired; and

5. Any or all of the above are given to reward viewer cooperation, based on the value to the advertiser of the information disclosed.

All of these rewards and incentives are given to the viewer in proportion to the quality, value, completeness and timeliness of the information divulged. For example, revealing basic personal profile information would result is a 10% reduction of commercials, while divulging in-depth financial information might result in a 50% reduction. A cooperating viewer could be given a one-time reward of a commercial-free program, or coupons, or any variant of the incentives offered. This is done by making an assessment, for each cooperating viewer, of the Expected Revenue Per Ad (ERPA) for each ad which might be delivered to that viewer. For example, if all other factors were equal, an ad for golf equipment delivered to a viewer who bought $5000 of golf equipment in the prior year would have a higher ERPA than the same ad delivered to a viewer who bought $1000 of golf equipment in the same period. Thus, it can be determined that a particular form of program material must carry 600 units of ERPA per half-hour of content. This could be composed of a great number of low ERPA-value ads, or a small number of high ERPA-value ads, or any combination.

Furthermore, the formula by which rewards are given may vary according to program content, time of day and seasonally. For example, a first-run movie may include a minimum number of commercial pods, whereas, the number of pods for an older movie may be considerably less. The number of pods for the first-run movie may be higher during prime time hours as opposed an after midnight airing. There might also be seasonal factors in determining the minimum number of pods.

There are a number of ways in which a viewer can provide in-depth personal profile information, including by:

responding to telephone or mail questionnaires;

television remote controller messages to a settop converter;

a web browser or e-mail;

Internet appliances (e.g., WebTV);

Authorized release of data from banks, credit card companies, etc.

In the advertising industry, the methods of analyzing such data are well known. Use of such data to determine the viewers that would be desirable candidates to receive a targeted ad and at what frequency are also well known.

The method of rewarding the viewer and inserting targeted ads is as follows:

A tool known as the Content Selector (CS) is incorporated into the viewer's settop converter, television receiver, VCR, PTV, web browser, etc., the purpose of which is to first accept the viewer's tuning selection and then automatically select from a plurality of channels the program content corresponding to the viewer's reward level, delivering that content to the display.

Typically, the CS will be assigned one or more unique ID numbers, each corresponding to a viewer. Depending upon the configuration, the CS is made aware of the viewer's reward level in any or all of the following ways:

Lookup in a server database using the viewer ID;

Download over the Internet;

CATV or Satellite signals to addressable converters; or

Signals transmitted over the air (RF receiver, pager, RDBS, etc.)

In circumstances where content can be delivered to the viewer directly as opposed to narrow casting, the CS can be incorporated into the web server, Video on Demand server, etc.

A second tool, the Ad Inserter (AI), in also incorporated in the same manner as the CS for the express purpose of inserting the targeted ads into the viewer's program content. The AI can operate in the same manner as described in the prior art or as a combination of those methods.

Delivery of television programs, and, consequentially targeted ads, to the viewers can be visualized as falling into three separate categories:

Point-to-Point—Video on Demand, Internet Television, etc.

Point-to-Few—delivery over cable, satellite, etc.

Point-to-Many—traditional terrestrial broadcasting;

Point-to-Point

In this embodiment, program content is delivered directly from the source to the viewer, i.e., point to point. Video on Demand, Internet Radio, Internet TV, and web pages are all examples of content that is served up and delivered specifically at the request of the viewer. Such program content is not constrained by the “party-line” attribute of CATV and can be highly customized to match any combination of the specified reward levels and ad targeting for that viewer.

Typically, the CS and AI are incorporated into the servers rather than at the viewer's home and a database of viewer IDs is also maintained on the server. The role of the CS is minimized because only a single program stream is required. For example, as a Video on Demand program is being delivered to the viewer, the stream can be halted at any point for the AI to insert a targeted ad (according to the viewer's profile and reward level) after which the program simply continues where it left off.

Internet advertising faces much of the same problems as television commercials and can reap the same benefits with properly targeted ads. Typical rewards to cooperating “visitors” can be the reduction in web ads, targeted ads, and ads targeted according to the site visited. In the last case, for example, if a participant visits a financial site and it is known from his profile that he has a credit card with Citibank, he may be presented with an ad from Citibank offering current customers a promotion or, an ad or promotion from one of Citibank's rivals.

Point-to-Few

Cable television systems, direct broadcast satellite, etc. fall into this category due to their ability to reach groups of subscribers. For example, a typical cable system is geographically constrained with one or more head-ends distributing programming to its subscribers in the fashion of a party line. Real-time insertion of commercials from local advertisers is routinely performed and narrow casted to all subscribers on a particular head-end.

Newer cable systems and digital satellite have the ability to deliver several hundred channels of programming. On some systems, a number of channels are dedicated to deliver time-delayed programs to subscribers. For example, a pay-per-view (PPV) movie may be shown on eight different channels, for example, channels 260 through 267, each offset by 15 minutes so that a subscriber would never have to wait more than 15 minutes for a show to start. When the subscriber has elected to view a movie on PPV channel 6, she tunes her settop converter to that channel, however, the firmware in the settop automatically and transparently tunes to channel 266 where that movie is about to start.

Following this model, a cable or satellite operator sets aside a number of channels, each carrying the same program but with viewer rewards incorporated into the content (e.g., rewards of type 2, type 3 or a combination). When that program is tuned by the viewer, the CS (incorporated into the settop unit) automatically tunes to the channel that corresponds with that viewer's reward level and, targeted ads are inserted accordingly by the AI at the appropriate places and times.

Typically, a broadcaster will have a limited number of commercial spots to sell for each program. Accordingly, the number of targeted ads for the AI to deliver will probably be limited to a finite number, generally far less than the number of participating viewers. As a result, an ad that closely targets a viewer's personal profile may not be available. An alternative method to this situation is to first assign a category to each ad and then narrow cast those ads to the viewer having a category that corresponds to that viewer's profile and which are also suitable as a reward.

Another method of rewarding viewers concerns those that use personal television products. The CS and AI functionalities, as described for inclusion in the cable settop, are just as easily incorporated in PTV products to provide the viewer with the same tuning capabilities and features. Because the CS and AI are integrated into the PTV, they can fully exploit the features of those devices. For example, the number of commercials and/or repositioning of targeted ads into a fewer number of pods can be accomplished under control of the CS and AI by using the instant rewind and playback capabilities of these products.

Point-to-Many

This category consists of traditional terrestrial broadcasts by television and radio stations. In the usual case, the program material is viewed in real-time, as it is broadcast, however it may also be recorded by the viewer for later viewing using a VCR or devices such as Tivo or ReplayTV. While the program material and the duration of each interspersed set of advertising material (each pod) is identical for all viewers, the content of the ads can be customized to each viewer. In this environment, the personal profile information is gathered by a gathering device (the GD) at the viewer's location through which the program material is transmitted, such as a cable descrambler. Gathered profile data is transmitted to an appropriate consolidation point using one of a number of techniques such as:

Over the cable line, if the GD is cable connected, and if two-way communication to the cable hub is available.

Over a dial-up phone line connected to the GD

Over the Internet, if the GD is connected to the Internet

The GD may itself contain the software that analyzes the profile data in order to categorize the viewer so as to be able to select targeted advertising. Alternatively, this task is performed at the consolidation point and the results returned to the GD, using one of the above communication techniques, or by piggybacking this information (suitably tagged with an identification code that ties it to the viewer or to the GD so as to allow the GD to recognize it) in the regular broadcast data, using a variety of known techniques such as utilizing the blanking interval or a sideband.

The GD then collects and stores a stockpile of ads, matched to the viewer's profile. This may be done proactively, by accessing the consolidation point via cable, phone or Internet. Alternatively, the set of targeted ads (applicable to all profiles) is included in the regular broadcast data, and the GD selects, picks up and stores within its own memory only those ads matching the current viewer's profile, or that of other members of the viewer's household.

Thereafter, as the viewer views broadcast program material, the GD replaces the broadcast ads, which are targeted as to their location in the broadcast stream and their duration, with selections from the targeted ads that the GD has in its memory.

As further inducement to the viewer to supply profile information, some of the standard ads may be replaced, not with targeted ads, but rather with brief program material (music videos, household tips, etc.). And if the GD is a device that records the broadcast program for later viewing, it is able to go beyond simple substitution of ads to substitution combined with reducing the duration of each pod. Note that the GD is not intended to be limited to a device that is separate from a television set. The teachings of the invention include the expedient wherein, television sets are modified so that they incorporate within circuit sections that perform the function of the GD as described above. In this case, a television set is typically provided with optional telephone connections and associated circuitry which enable the GD within the TV to communicate with the broadcasting entities as described above.

Note further that the collection of profile information from viewers may be through communications between viewers and the GD, via a remote controller device operable by the viewers that communicates with the GD. The GD may optionally contain software that uses the television screen to communicate instructions to the viewers concerning how to operate the remote controller to input personal profile information. In this connection, the invention includes the expedient that the remote controller or the GD contains voice recording and/or voice recognition circuitry that records and optionally recognizes voice information from viewers, which is then processed and transmitted to the broadcasting entity in order to develop the profile information, the gathering of which constitutes an important feature of the present invention.

Communications between the GD and the broadcasting entity can take place in accordance with the formats described previously. In addition, the invention also includes the expedient of embedding within the GD a special wireless, cellular telephone consisting of the bare telephone circuitry without any human actuatable parts, such as a keyboard, a display or the like. Rather, the internal, special wireless telephone is designed to wirelessly call-up the broadcasting entity's reserved telephone numbers (which may change from region to region) and the wireless telephone may then call (or be called by) the broadcasting entity to provide as well as receive information such as configuration data, personal profiles, advertising inserts, etc. Note that there is no cost to the television viewers or owner of the TV as the telephone subscription for the internal telephone is owned entirely by the broadcasting entity. Also, while they call individually, these internal phones may be designed to respond as “party line” telephones so that their respective GDs may be “programmed” simultaneously. Or these telephones may be internally programmed to transmit to the broadcaster or information consolidator while connected thereto in groups, as “party line” phones, using token passing techniques or in the manner that computer workstations communicate with their servers, using collision avoidance and error correcting techniques.

In fact, a clearinghouse can be established for such telephones embedded in the television sets through which a variety of broadcasting entities can poll their resources to obtain the user profile information that they desire. This can be done for both convenience, security as well as for viewer confidentiality considerations.

Thus far, the ad inserting function of the present invention has generally been described as involving the insertion of advertising material between programming content. However, the invention includes, particularly with the presence of the GD, the ability to scroll textual matter at the bottom of the television screen simultaneously with the broadcasting and viewing of program content. This would enable local and comparatively small business establishments, e.g., local department stores, to advertise to neighborhood viewers sales, special promotions, etc. The textual information is not necessarily commercial and may comprise announcements by governmental agencies about local government services, traffic regulations and the like. Of course, the GD may communicate with the broadcasting entity by means other than a cellular telephone, as described heretofore, including by communicating via hard-wire, customer-owned telephone connection or by detecting broadcasted information contained in side bands or otherwise interleaved with the broadcasting content.

As more fully explained below, the GD may also be used as a voice recognition device that recognizes the persons who are viewing specific programming content. This is done by providing an ability in the GD to communicate with viewers orally, including by requesting viewers to state their names when the device is first programmed with personal profile data and thereafter, periodically as well as during the playing of advertisements. In this fashion, the broadcasting content can be chosen and inserted based on whether there is a single person or several persons watching the particular program content.

Family Members

As introduced above, while Mr. Jones may be the bread winner, other family members may fall into demographic groups that certain advertisers are eager to woo. Hence there is a real need to differentiate viewers in the same household. One such manner is via a remote control that the viewer uses to enter a PIN code into the settop converter or receiving unit or the GD, that unit then providing rewards and targeted ads in accordance to the methods described above.

A common situation is where two or more family members are watching the same television program. The system permits the broadcaster to select any combination of reward levels appropriate to the viewing audience and optimize the delivery of targeted ads accordingly. For example, if Mr. Jones and his teenage son are watching football, a commercial for Nike sneakers might command a bigger ad dollar when targeted to the teenager as opposed to a car commercial to Mr. Jones. The AI, which is aware of all viewers in a household, can be instructed to optimize the insertion in such cases.

Benefits

This invention provides mutual benefits to both viewer and advertiser. Viewers are rewarded for divulging personal profile information by combinations of coupons, cash, fewer commercials and commercials tailored to their interests.

Advertisers benefit by reaching viewers more likely to watch their commercials and buy their products, by receiving valuable market research data, and presumably, a lower cost per spot.

Television service providers now limited to one advertisement per spot are now able to run multiple commercials in the same spot and, presumably, while running fewer ads altogether, receive more total ad revenue by charging a higher price per audience size for each ad, justified by the greater value of targeted ads.

The delivery of targeted ads and rewards can be prioritized to reach the most desirable member of a viewing household.

An additional benefit is the ability to reach certain demographic groups that are less likely to divulge personal information. The invention provides several features that encourage divulgation of personal information. This includes encryption software in the GD, etc., so that personal information being transmitted is encrypted using well known techniques, e.g., RSA technology. Second, the gathering of personal information and the broadcasting of program content and advertisement are preferably separated from one another, by the provision of a separate preferably central entity through which personal information is handled. This separate (and preferably independent) entity which may be referred to as the PDGE (Personal Data Gathering Entity) is the only entity where the names and addresses of the persons divulging the information resides. Advertisers and broadcasters have access only to anonymous account numbers at the PDGE and the personal information or profiling data that they represent. Program participants can be assured privacy as well as freedom from junk mail and the like.

An additional benefit for both participating viewers and advertisers is the ability to use this market data to form a geographic profile of the general viewing audience with greater detail. The benefits derived for all viewers is that advertisers will be able to judge the profiles geographically in deciding how to spend their ad dollars with other viewers in the same area benefitting as well.

Additional Features of the Present Invention

The present invention presents a number of opportunities to the advertising and media information industries for improving the quality of information returned and the ability to further refine that information to obtain inferences that would not otherwise be available.

Viewer Participation

The ability to target ads is worthless if the intended audience is not reached. Providing incentives to certain viewers in the hope that they will watch targeted ads may not provide the intended results if some measure of compliance cannot be ascertained.

For example, a viewer desiring to reduce the number of commercials may provide personal information but continues to evade exposure to such targeted ads. Many viewers of network television routinely channel surf during commercials after which they return to the original program.

Furthermore, advertisers spend considerable amounts of money to produce and then air commercials. Many also put effort into refining their commercials using focus studies. While this can be important, nothing is more valuable than having actual viewing data obtained from viewers that are likely to watch. Similarly, it can be very important for an advertiser to know what is and is not working for a competitor.

The present invention overcomes these problems as follows:

Determining Viewer Identity

As already mentioned, there is a need to identify the viewer, especially so in a multi-member household, in order to deliver the proper targeted ads at the correct reward level.

It was noted that a remote control is used by the viewer to enter a PIN code or that voice recognition identifies her to the system. This can be further improved by incorporating an LED display into the settop unit (or the GD) to provide the user with positive feedback that his entry is correct. Alternatively, the art described by McKenna et al. (U.S. Pat. No. 4,816,904) concerns a method of using a remote control to provide visual overlays of textual information on the TV screen so that the viewer can verify his data entry or to select from a list of options. In a similar manner, the viewer can signal his cessation of viewing.

Determining Viewer Presence

It is quite common for viewers to leave during commercials or other breaks and return shortly thereafter. One manner of detecting the actual presence of viewers is to incorporate the methodology of Scarampi (U.S. Pat. No. 4,931,865) which detects the presence of viewers by measuring the reflection of infrared light by their eyes. The viewing data thus generated provides a direct measure of their presence. The description to follow describes how this data can be linked with programming data to determine if a program and/or commercial has actually been watched. The contents of the U.S. Pat. Nos. 4,816,904 and 4,931,865 are incorporated by reference herein.

Determining Actual Viewing Including Commercials Watched

The prior art presents a number of methods (e.g., McKenna et al.) for obtaining viewing event data, i.e., data corresponding to the tuning of the television or settop receiver. Briefly, tuning event data provides a direct correspondence with delivered program (and commercial) content to the viewer's household. Employing a knowledge base of programming indexed by date, time and broadcast source (channel, etc.) the event provides an accurate relationship to the delivered program content—when it began, ended, how many interruptions and how long, etc.

A variety of other controls may be incorporated to encourage the viewers' attention to advertisement. One is to require the viewer to reply during the playing of commercials as by clicking the remote controller in response to prompts from the television set or from the settop box unit, once or several times. If the viewer responds to all prompts, the reward may be set at a higher level. Further, the viewer may be asked to rate commercials based on a variety of factors. The invention may also provide instant rewards such as the flashing a number of frequent flyer mileage being awarded responsive to the viewer's participation.

With the GD of the present invention, viewers can be rewarded further by a GD that includes sufficient memory to hold broadcast content equivalent to several minutes, or even the length of a show. With this capability, the GD is also able to not only substitute advertisements but also, if allowed, consolidate program content to reduce the number of commercial breaks. All that is important is that program content ends as scheduled. A viewer with a high reward level may cash in rewards by being permitted to view certain programs without any commercials. The GD alerts the viewer when the commercial free content is ready for continuous, uninterrupted viewing.

Such viewing data when combined with the personal profile of the viewer is invaluable to broadcasters, advertisers, agencies, etc. For example, if a targeted ad is being directed to a viewer:

Is he actually viewing it?

Did she watch the entire commercial?

If not, did she time it out by leaving or channel surfing?

Is the current reward level justified?

Should the reward level be increased or decreased?

Benefits

Benefits of incorporating these features into the present invention include the ability to:

Determine the identify of one or more simultaneous viewers;

Determine the demographic profile of the audience in the viewing household;

Confirm delivery of targeted ads to the intended viewer(s);

Using viewing data, determine if the rewards being given the viewer are appropriate;

Provide advertisers with data concerning the delivery of their ads;

Provide data concerning the effectiveness of ads by competitors.

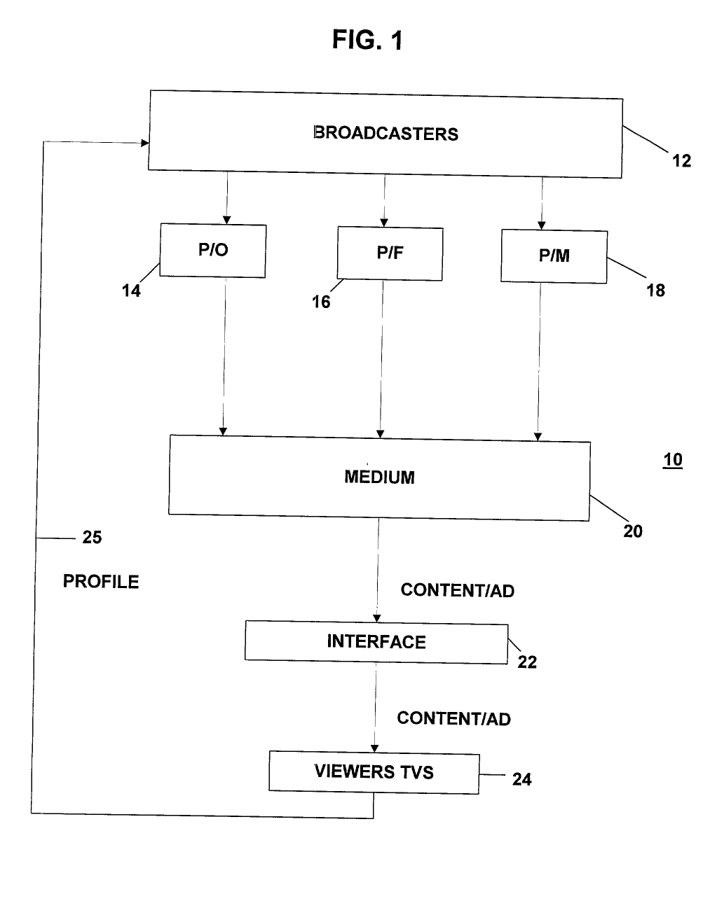

Reference is now made to FIGS. 1-3 which provide further explanation of various steps and aspects of the invention. As shown in FIG. 1, the system of the invention involves broadcasters 12 which represents the familiar broadcasters that broadcast public, free television, e.g. CBS, NBC, FOX, etc., as well as cable television operators and the like. Broadcasters 12 can be point-to-one broadcasters 14 and/or point-to-few broadcasters 16 and, indeed, point-to-many broadcasters 18 as heretofore described. These broadcasters transmit their program content and accompanying advertising through medium 20 which may represent the airwaves or satellite transmissions or cable transmissions or transmissions through the Internet and the like. Content consisting of various programs as well as accompanying advertising copy is channeled by interface 22 to the actual viewers' television sets 24, all in known and conventional fashion. The invention in FIG. 1 distinguishes itself over the prior art in that it shows that viewers provide profile information 25 to the broadcasters 12 which, in accordance with the teachings of the invention, results in the broadcasters providing various rewards to the viewers including reduced or modified or enhanced advertisements or more discriminated selected program content or combinations of the two.

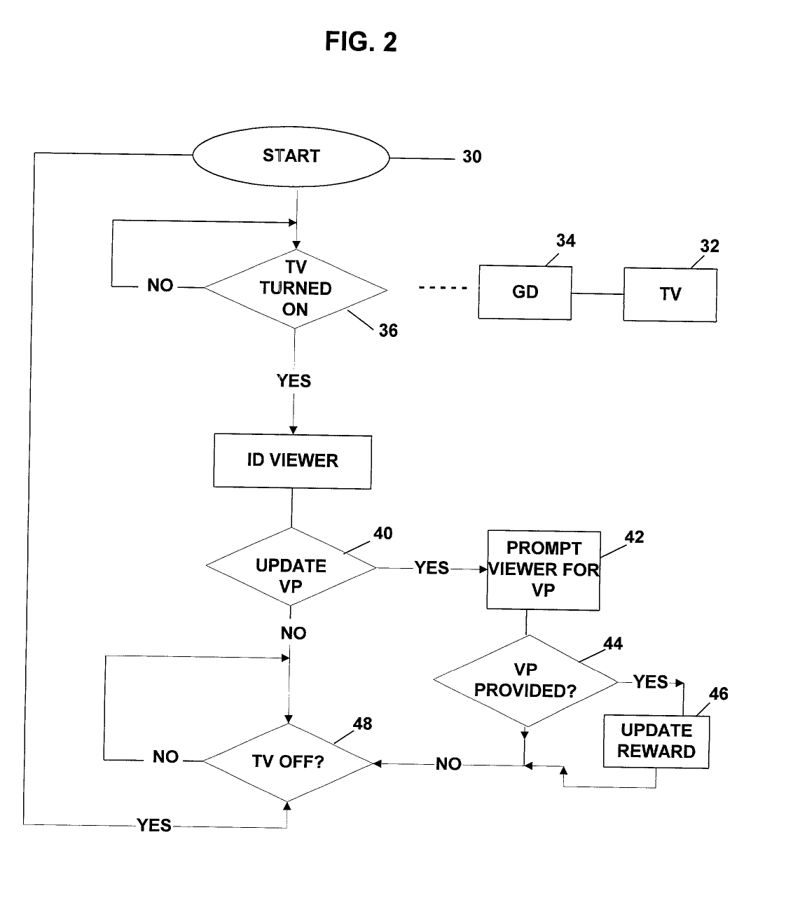

Referring to FIG. 2, software components of the invention which may reside in the local settop box or the GD 34 or the like, or alternatively at a central location, contains the usual initialization and general housekeeping routines as indicated at step 30. The software queries whether the viewer has turned on her television at decisional box 36 in response to appropriate inputs which, as indicated in FIG. 2, are typically to be provided from the GD 34 working in conjunction with the television set 32.

Once it has been detected that the television set has been turned on, the identity of the viewer is ascertained at step 38 and thereafter, at decisional box 40, the system queries whether it is time to either obtain viewer profile information or to update such information. If no, the program loops continuously as shown at 48 until the television set is turned off.

If on the other hand, it is time to obtain or to update viewer profile information, the program proceeds to step 42 which prompts the viewer for personal information. As noted previously, this step can be an interactive step or it can be a manual step involving the viewer filling-out a questionnaire or a calling the broadcaster 12 to update the information or the like. If the viewer has complied with the request for updated viewer information, then, as indicated at decisional box 44, the reward account of the viewer is updated at step 46. Otherwise, the program proceeds without providing further rewards or, in fact, perhaps by reducing previously granted rewards or without taking any further action.

Note that not all personal profile information needs to be proactively provided by viewers. The invention includes the variant that at least some of the information is passively gathered. For example, the GD may include a global positioning system (GPS) that automatically informs the broadcasters (directly or indirectly) about the viewer's location. Also as previously described, the GD 34 may contain the facilities for automatically gathering information about the viewers' viewing or listening habits, including what program content, commercials, etc are being watched. This information can be communicated, as noted before, in a variety of ways including via the Internet. As this implies, the GD 34 is so coupled to the television set 32 so that the GD is aware, through such coupling, when a television set is turned on and off, as well as where the television set is tuned.

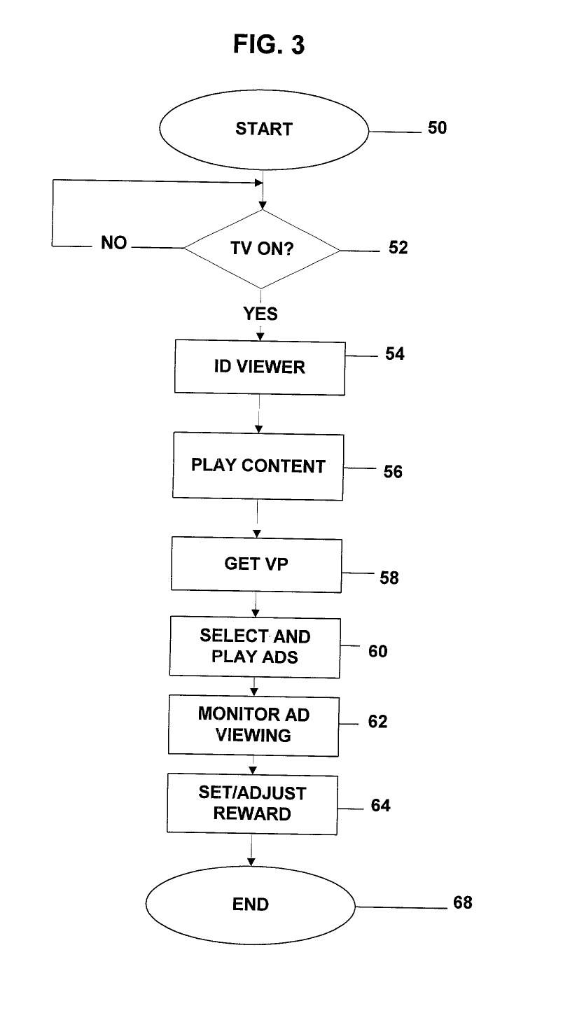

As indicated in FIG. 3 during normal running of the system, following initialization at the start of block 50, the program queries whether the television set has been turned on as indicated at 52. Once the television has been turned on, the viewer is identified at step 54 and thereafter is provided with program content at step 56. At the same time, the viewer profile is retrieved and advertisement content or program content is selected and arranged in accordance with the viewer profile, as indicated at steps 58 and 60.

As an optional step, the software monitors the viewer to determine if and/or to what extent the viewer is aware of or watches or otherwise pays attention to ads and, based thereon, sets or adjusts reward levels for future programming, as indicated at step 62-64.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A public broadcasting system operable with a facility for collecting viewers' profile data and for controlling program and/or advertisement content delivery to customers based on the viewers' profile data, the system comprising:
viewer profile data and a facility for gathering said viewer profile data and for providing the viewer profile data to a content controlling facility;
a content selector that selects for viewers program content; and
an advertising inserter which selects alternate advertising that is intended to selectively replace or supplement commonly provided advertising content, based on the viewer profile data.

2. The system of claim 1, in which the broadcasters include point-to-one broadcasters.

3. The system of claim 1, in which the broadcasters include point-to-few broadcasters.

4. The system of claim 1, in which the broadcasters include point-to-many broadcasters.

5. The system of claim 1, including a facility that sets rewards to viewers who provide viewer profile information.

6. The system of claim 5, in which the rewards comprise modifications to the commonly provided advertising content.

7. The system of claim 5, in which the rewards comprise the alternate advertising having reduced time durations.

8. The system of claim 5, in which the rewards comprise the provision of different types of advertisements.

9. The system of claim 5, in which the rewards comprise the replacement of the commonly provided advertising content with brief program material.

10. The system of claim 5, in which the rewards comprise the selection of advertising that are tailored to viewers, based on the viewers' profile information.

11. The system of claim 1, in which the viewers profile data is provided by viewers in accordance with different levels of specified viewer profile detail so as to enable providing different reward levels.

12. The system of claim 1, in which insertion of the alternate advertising is effected at an interface facility.

13. The system of claim 12, in which the interface facility is a central facility which is operated outside of viewers' homes.

14. The system of claim 12, in which the interface device is a gathering device.

15. The system of claim 14, in which the gathering device incorporates internal cellular telephone circuitry that automatically communicates with the broadcasters.

16. The system of claim 15, in which internal cellular telephones associated with a plurality of viewers are operated as party line telephones.

17. The system of claim 14, in which the gathering device comprises internal storage for storing program content and a facility that plays program content after a delay.

18. The system of claim 12, in which the interface facility comprises a device located in the home of the viewer.

19. The system of claim 18, in which the device is selected from a group consisting of: settop box, descrambler, VCR, GD, PTV, television receiver, Web browser and Internet appliance.

20. The system of claim 1, in which the broadcasters comprises a Web TV deliverer or a real television or a video-on-demand provider.

21. The system of claim 5, in which the rewards comprise a cash award.

22. The system of claim 5, in which the rewards comprise a reduction in the frequency or duration of television commercials.

23. The system of claim 5, in which the rewards comprise a combination of advertisements in advertising pods.

24. The system of claim 5, in which the rewards comprise the playing of only such commercials that are matched with the viewers' profile data.

25. The system of claim 1, in which the viewer profile information is communicated to broadcasters via viewer responses to questionnaires.

26. The system of claim 18, in which the viewer profile information is communicated to broadcasters via remote controller messages transmitted to the respective interface facility located at the respective homes of the viewers.

27. The system of claim 1, in which the viewer profile information is communicated to the broadcasters via the Internet.

28. The system of claim 1, in which the viewer profile information is communicated to the broadcasters through authorized release of data from financial institutions.

29. The system of claim 1, including a facility that selects either the program content or the alternate advertising by means of a server database.

30. The system of claim 1, including a facility that selects either the program content or the alternate advertising by downloading over the Internet.

31. The system of claim 1, including a facility that selects either the program content or the alternate advertising by Cable TV or satellite signals transmitted to addressable converters.

32. The system of claim 1, including a facility that selects either the program content or the alternate advertising by signals transmitted over the air.

33. The system of claim 1, further including an encryption software that encrypts viewers' profile information provided by viewers.

34. The system of claim 1, further including a facility that identifies viewers who are actually viewing program content.

35. The system of claim 34, in which the facility that identifies viewers includes a voice recognition facility.

36. The system of claim 34, in which the facility that identifies viewers' includes a facility that detects viewers' presence near a television set.

37. The system of claim 34, in which the facility that identifies viewers' includes a remote controller device operable by the viewers.

38. The system of claim 1, further including a central entity that manages viewer profile information in a manner that protects the confidentiality of viewers identities from the broadcasters.

39. A public broadcasting system involving broadcasting of live program content divided into segments with intervals separating the segments and advertising content provided in the intervals, the system comprising:
a broadcasting facility for broadcasting the live program content and a plurality of receiving devices for receiving the live program content and for playing the live program content to viewers substantially without delay;
advertising players coupled with corresponding ones of the receiving devices, the advertising players including a facility for receiving and pre-storing the advertising content; and
an advertising content inserter operable with the advertising inserter and the receiver for dynamically and interactively inserting portions of the pre-stored advertising content into the live program content being provided to viewers, in a manner that the pre-stored advertising content and the live program content are presented in integrated form to viewers.

40. The system of the claim 39, further including an interface facility that enables viewers to provide viewer profile data to broadcasters.

41. The system of claim 40, further including a facility in the advertising content inserter that selects segments from the pre-stored advertising to be inserted in the live broadcast based on viewer profile data of respective viewers.

42. The system of claim 39, in which the broadcasters include a radio broadcaster.
